(19) United States
(12) Patent Application Publication
(10) Pub. No.: US 2019/0120387 A1
(43) Pub. Date: Apr. 25, 2019

(54) Labyrinth Seal With Sensors

(71) Applicant: MAN ENERGY SOLUTIONS SE, Augsburg (DE)

(72) Inventor: Kolja METZ, Berlin (DE)

(21) Appl. No.: 16/099,626

(22) PCT Filed: May 2, 2017
(86) PCT No.: PCT/EP2017/060427

§ 371 Date: Nov. 7, 2018

(30) Foreign Application Priority Data
May 9, 2016 (DE) 10 2016 108 463.8

(51) Int. Cl. F16J 15/453; F16C 33/80; F16J 15/06; F16J 15/447; G01H 11/02

(52) U.S. Cl. CPC F16J 15/453; F16C 33/80; F16C 2233/00; F16J 15/4472; G01H 11/02; F16J 15/064

(57) ABSTRACT

A labyrinth seal for sealing a running clearance between a stator-side component, in particular a housing, and a rotor-side component, in particular a shaft, having a stator-side sealing body which includes labyrinth tips facing the rotor-side component. The stator-side sealing body is made of an electrically non-conductive material, and wherein the stator-side sealing body accommodates sensors for detecting oscillations of the rotor-side component.

The invention relates to a labyrinth seal.

Labyrinth seals for sealing a running gap between a rotor-side component, in particular a shaft, and a stator-side component, in particular a housing, are thoroughly known from the prior art. Accordingly, such labyrinth seals comprise stator-side sealing bodies, which have labyrinth tips facing the rotor-side component, adjoin with their labyrinth seals the rotor-side component and thereby seal the running gap between the rotor-side component and the stator-side component.

In labyrinth seals known from practice, the stator-side sealing bodies, which comprise the labyrinth tips, are produced from a metallic material, in particular from aluminium. The rotor-side component likewise consists of a metallic material, in particular of a steel alloy, the hardness of which is greater than that of aluminium.

From practice it is already known, furthermore, to detect oscillations of the rotor-side component in the stator-side component via sensors, for example by way of path transducers. Here, the sensors according to the practice are positioned with adequate axial distance from the labyrinth seals for detecting oscillations of the rotor-side component, in order to make possible an oscillation measurement without interference. The installation space needed for the oscillation sensors causes the installation space requirement to increase.

Starting out from this, the present invention is based on the object of creating a new type of labyrinth seal.

This object is solved through a labyrinth seal according to claim 1. According to the invention, the stator-side sealing body consists of an electrically non-conductive material, wherein the stator-side sealing body receives sensors for detecting oscillations of the rotor-side component.

With the invention it is proposed for the first time to produce the stator-side sealing body for a labyrinth seal from an electrically non-conductive material and position sensors for detecting oscillations of the rotor-side component in the stator-side sealing body. By embodying the stator-side sealing body from an electrically non-conductive material it is ensured that the sensors for the oscillation detection of the rotor-side component integrated in the stator-side sealing body can record measurement values without interference. By integrating the oscillation sensors in the stator-side sealing body, the installation space requirement can be reduced.

Preferentially, the electrically non-conductive material of the stator-side sealing body is heat-resistant at temperatures of up to 100° C., furthermore oil-resistant and additionally dimensionally stable at pressure differences of up to 100 mbar. Such a material for the stator-side sealing body is particularly preferred.

According to an advantageous further development, the electrically non-conductive material of the stator-side sealing body is a plastic, preferentially a polyoxymethylene plastic. The stator-side sealing body can consist of a fibre-reinforced plastic. The use of polyoxymethylene plastic is preferred for cost reasons and provides a sealing body with adequate heat resistance, oil resistance and dimensional stability.

According to an advantageous further development, the respective sensor is inserted into a bore, in particular into a barrier gas supply bore of the stator-side sealing body. Because of this, a particularly compact design of the labyrinth seal with oscillation sensors integrated in the stator-side sealing body is possible.

Preferred further developments of the invention are obtained from the subclaims and the following description. Exemplary embodiments of the invention are explained in more detail by way of the drawing without being restricted to this.

There it shows:

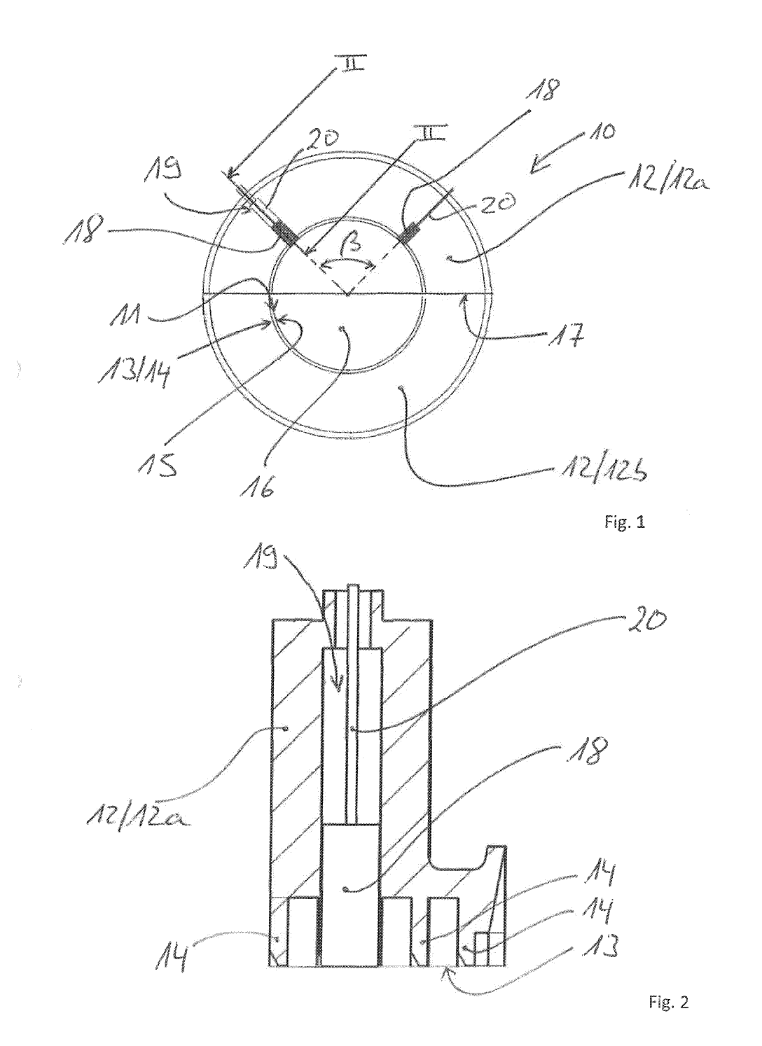

FIG. 1: a labyrinth seal in axial viewing direction; and

FIG. 2: a radial section through the labyrinth seal of FIG. 1 in section direction II-II.

The invention relates to a labyrinth seal.

FIG. 1 shows a labyrinth seal 10 for sealing a running gap 11 between a stator-side component, in particular a housing and a rotor-side component, in particular a shaft. The labyrinth seal 10 comprises a stator-side sealing body 12, which is inserted into a recess of the stator-side component which is not shown, in particular the housing and which on a face 13 located radially inside comprises labyrinth tips 14, which seal the running gap 11 between the stator-side sealing body 12 and a radially outer surface 15 of a rotor-side component 16.

The stator-side sealing body 12 of the labyrinth seal 10 is produced from an electrically non-conductive material. This material is heat-resistant in particular at temperatures of up to 80° C., preferably or up to 100° C., furthermore oil-resistant and additionally dimensionally stable at pressure differences of up to 50 mbar, preferably of up to 100 mbar.

Preferentially, the stator-side sealing body 12 is produced from an electrically non-conductive plastic, preferentially from polyoxymethylene plastic (POM plastic) or alternatively from polytetrafluoroethylene plastic (PTFE plastic) or from a polyetheretherketone plastic (PEEK plastic). Such plastics fulfil the abovementioned conditions and allow a simple-cost-effective production of the stator-side sealing body 12. The plastic can be a fibre-reinforced plastic, for example reinforced with glass fibres or carbon fibres.

In the shown exemplary embodiment, the stator-side sealing body 12 of the labyrinth seal 10 is assembled from two halves 12a, 12b, wherein FIG. 1 visualises the separating plane 17 between these two halves 12a, 12b of the stator-side sealing body 12.

The stator-side sealing body 12, in the shown exemplary embodiment the half 12a of the same, receives sensors 18 for detecting oscillations of the rotor-side component 16. These sensors 18 are preferentially path transducers, which detect a change in the gap of the running gap 11 by way of eddy currents induced in the metallic material of the rotor-side component. In the process, an HF-signal or high frequency signal with defined energy is generated from an auxiliary voltage. This HF-signal is fed into an encoder of the sensor 18, wherein the energy is transmitted back to a coil of the sensor 18. When the metallic, rotor-side component 16 cuts the energy field, eddy currents are induced in the surface of the rotor-side component 16 and a measurable energy loss occurs. The smaller the running gap, the higher is the energy loss. This measurement principle of the path transducers is generally known.

Here, the stator-side sealing body 12, which consists of the electrically non-conductive material, preferentially accommodates two such sensors 18, which are offset on the circumference relative to one another by an angle β of 90°±5°.

Typically, the stator-side sealing body 12 of a labyrinth seal 10 comprises at least one barrier gas supply bore 19. For the easy integration of the respective sensor 18 in the stator-side sealing body 12 it can be provided to position the respective sensor 18 in such a barrier gas supply bore 19 and route a cable 20 for contacting the sensor 18 to the outside via this barrier gas supply bore 19.

Accordingly, with the invention present here it is proposed to integrate sensors, which serve for detecting oscillations of a rotor-side component, in labyrinth seals, namely in the stator-side sealing body of such a labyrinth seal, which is produced from an electrically non-conductive material, in particular from a suitable plastic. By integrating the sensors in the stator-side sealing body of the labyrinth seal, installation space can be saved. Because of the fact that the stator-side sealing body is produced from the electrically non-conductive material, the oscillation sensors can pick up and provide corresponding measurement values without interference.

### LIST OF REFERENCE NUMBERS

10 Labyrinth seal
11 Running gap
12 Sealing body
12a Sealing body half
12b Sealing body half
13 Face
14 Labyrinth tip
15 Face
16 Component
17 Separating plane
18 Sensor
19 Barrier gas supply bore
20 Cable

1.-10. (canceled)

11. A labyrinth seal for sealing a running gap between a stator-side component and a rotor-side component, comprising:
a stator-side sealing body comprising an electrically non-conductive material;
labyrinth tips facing the rotor-side component; and
at least one sensor configured to detect oscillations of the rotor-side component and received in the stator-side sealing body.

12. The labyrinth seal according to claim 11, wherein the at least one sensor is a path transducer that detects a change in a gap of a running gap via induced eddy currents.

13. The labyrinth seal according to claim 12, wherein the stator-side sealing body receives two sensors that are offset by 90°±5° on a circumference.

14. The labyrinth seal according to claim 11, wherein the electrically non-conductive material of the stator-side sealing body is:
heat-resistant at temperatures of up to at least one of 80° C. and 100° C.,
oil-resistant, and
dimensionally stable at pressure differences of up to at least one of 50 mbar and 100 mbar.

15. The labyrinth seal according to claim 11, wherein the electrically non-conductive material of the stator-side sealing body is a plastic.

16. The labyrinth seal according to claim 15, wherein the plastic is a fiber-reinforced plastic.

17. The labyrinth seal according to claim 15, wherein the plastic is a polyoxymethylene plastic.

18. The labyrinth seal according to claim 15, wherein the plastic is a polytetrafluoroethylene plastic.

19. The labyrinth seal according to claim 15, wherein the plastic is a polyetheretherketone plastic.

20. The labyrinth seal according to claim 11, wherein the at least one sensor is inserted into a bore of the stator-side sealing body.

21. The labyrinth seal according to claim 20, wherein the bore is a barrier gas supply bore.

22. The labyrinth seal according to claim 11, wherein the stator-side component is a housing and the rotor-side component is a shaft.
